(19) United States
(12) Patent Application Publication
(10) Pub. No.: US 2026/0361874 A1
(43) Pub. Date: Nov. 12, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US); Peking Univeristy, Beijing (CN)

(72) Inventors: Longtao FENG, Beijing (CN); Huiwen REN, Beijing (CN); Zhao WANG, Beijing (CN); Yuwen HE, Los Angeles, CA (US); Siwei MA, Beijing (CN); Li ZHANG, Los Angeles, CA (US)

(21) Appl. No.: 19/724,608

(22) Filed: Jun. 29, 2026

Related U.S. Application Data
(63) Continuation of application No. PCT/CN2024/143376, filed on Dec. 27, 2024.

(30) Foreign Application Priority Data
Dec. 29, 2023 (WO) PCT/CN2023/143516

(51) Int. Cl. H04N 19/124; H04N 19/139; H04N 19/167; H04N 19/172; H04N 19/176

(52) U.S. Cl. CPC H04N 19/124; H04N 19/139; H04N 19/167; H04N 19/172; H04N 19/176

(57) ABSTRACT

Embodiments of the present disclosure provide a solution for video processing. In a method for video processing, for a conversion between a current frame of a video and a bitstream of the video, a frame-level importance for the current frame and a block-level importance for the current frame are determined. A block-level quantization parameter adjustment for the current frame is determined based on the frame-level importance and the block-level importance. The conversion is performed based on the block-level quantization parameter adjustment.

### CROSS-REFERENCE TO RELATED APPLICATIONS

This application is a continuation of International Application No. PCT/CN2024/143376, filed on Dec. 27, 2024, which claims the benefit of International Application No. PCT/CN2023/143516 filed on Dec. 29, 2023. The entire contents of these applications are hereby incorporated by reference in their entireties.

### FIELDS

Embodiments of the present disclosure relates generally to video processing techniques, and more particularly, to block-level quantization parameter adjustment.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current frame of a video and a bitstream of the video, a frame-level importance for the current frame and a block-level importance for the current frame; determining a block-level quantization parameter adjustment for the current frame based on the frame-level importance and the block-level importance; and performing the conversion based on the block-level quantization parameter adjustment. The method in accordance with the first aspect of the present disclosure adjust the block-level quantization parameter considering both the frame-level importance and the block-level importance. In this way, the coding performance and the coding efficiency may be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a frame-level importance for a current frame of the video and a block-level importance for the current frame; determining a block-level quantization parameter adjustment for the current frame based on the frame-level importance and the block-level importance; and generating the bitstream based on the block-level quantization parameter adjustment.

In a fifth aspect, a method for storing a bitstream of a video is proposed. The method comprises: determining a frame-level importance for a current frame of the video and a block-level importance for the current frame; determining a block-level quantization parameter adjustment for the current frame based on the frame-level importance and the block-level importance; generating the bitstream based on the block-level quantization parameter adjustment; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a flowchart of a method for video processing in accordance with embodiments of the present disclosure; and

FIG. 5 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

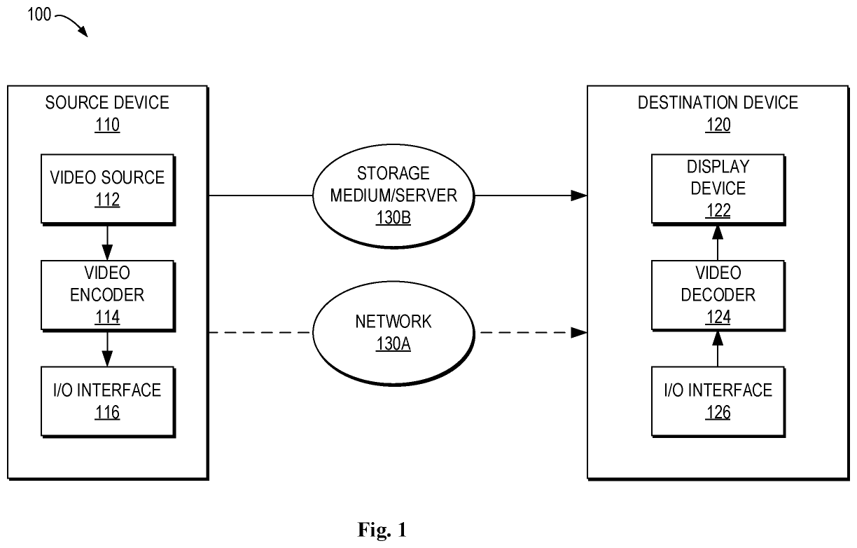

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

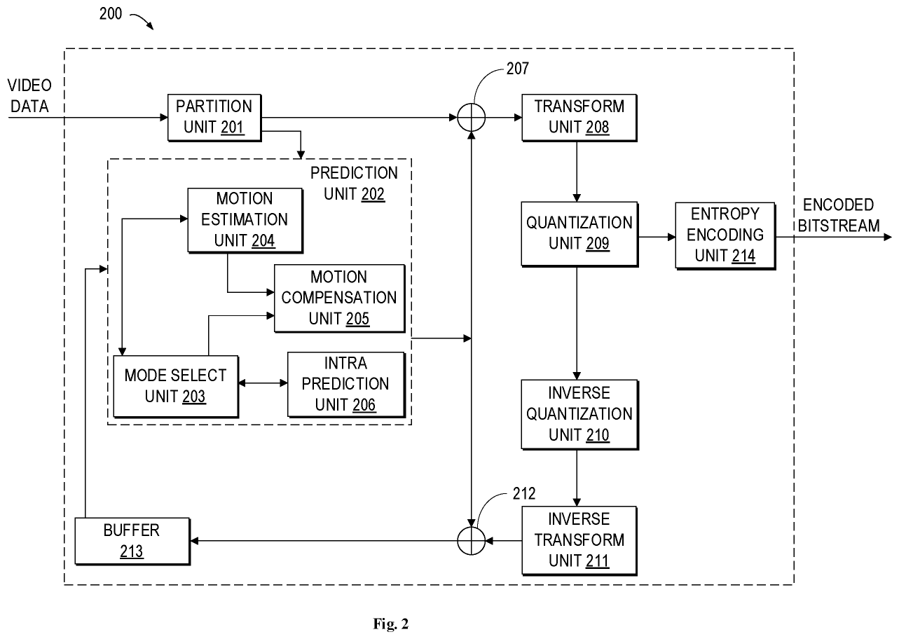

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

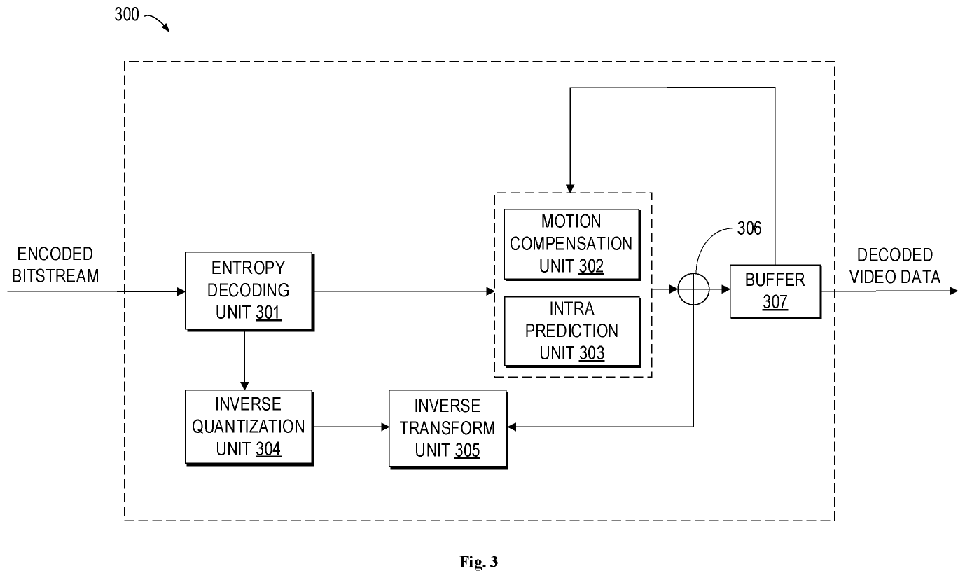

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Introduction

Video has become the most popular form of information today. Every day, a vast amount of video content is transmitted and stored on the internet. However, the sheer volume of these videos poses significant challenges for transmission and storage. To address these issues, video compression is necessary. Video compression, also known as video encoding, has been extensively studied in both academic and industrial circles. The Joint Video Experts Team (JVET), formed by the ITU-T Video Coding Experts Group (VCEG) and the ISO/IEC Moving Picture Experts Group (MPEG), has developed several generations of video coding standards over the past decades. The latest standard, Versatile Video Coding/H.266, completed in 2020, marks a significant advancement. Compared to the previous standard, High Efficiency Video Coding (HEVC)/H.265, it can save up to 50% of the bitrate while maintaining the same video quality.

In the process of video encoding, each frame is typically assigned to different types: Intra Pictures (I-frames), Predicted Pictures (P-frames), and Bi-predictive Pictures (B-frames). I-frames are encoded using only the current frame's information, while P-frames and B-frames are encoded using both the current frame's information and previously encoded frames. Therefore, P-frames and B-frames are much more efficient in encoding than I-frames. Focusing on different frame types and quantization parameter settings, existing technologies mainly aim to maximize encoding efficiency. This usually involves allocating different frame types and quantization parameters based on the reference relationships between different frame types. Since the encoding of I-frames does not depend on other frames, the first frame of a video and the first frame of a Group of Pictures (GOP) are typically set as I-frames. Given their reference importance for subsequent frames and their lower encoding efficiency, I-frames are usually allocated a higher bitrate. In contrast, P-frames and B-frames, having reference frames and higher encoding efficiency, are usually allocated a lower bitrate. This uneven bitrate allocation results in significant fluctuations in the bitrate of the encoded video across different frames.

### 2. Problem Statement

Existing video encoding technologies, under the Random Access configuration, utilize a hierarchical coding structure where higher-level frames reference lower-level ones. Typically, the higher the hierarchy level, the more reference frames there are, leading to a higher encoding efficiency. As a result, higher hierarchy levels are allocated a lower bitrate. While this hierarchical coding structure and its bitrate allocation method significantly improve video encoding efficiency, the substantial disparity in bitrate allocation often results in I-frames having a much higher bitrate compared to other frames. Consequently, the bitrate of the encoded video fluctuates greatly across different frames. Such substantial bitrate fluctuations will introduce a longer latency and more congestions during transmission, especially in applications with limited bandwidth resources, necessitating a cap on the video's maximum bitrate. To better utilize bandwidth resources without impacting the video's encoding efficiency, it is necessary to reduce the bitrate allocation of I-frames as much as possible, thereby minimizing the video's bitrate fluctuations.

### 3. Proposed Solutions

This present disclosure introduces a method for adaptive block-level quantization parameter adjustment for I-frames based on block importance and frame importance. Initially, the frame importance of the current I-frame for subsequent frames to be encoded is analyzed. This is followed by an assessment of the block importance of each image block within the current I-frame in relation to subsequent frames to be encoded. Finally, based on the importance of the block and the frame, the current block's quantization parameter adjustment value is calculated, allowing for the modification of the quantization parameters of the current image block. This method ultimately reduces the bitrate of the I-frame and the fluctuation of the video bitrate, without impacting the encoding efficiency. It enables more effective utilization of the transmission bandwidth.

### 3.1 Motion Search

First, identify the 4 frames before and after the current I-frame I₀, namely B₁, B₂, B₃, B₄, B₅, B₆, B₇, Bg in total. These frames, along with I₀, are downsampled twice along their width and height dimensions to obtain two lower resolution images. Starting with the image of the lowest resolution, the image blocks of the four preceding and succeeding frames are traversed. Within a certain range of the corresponding position of the current image block, the most similar image block in IO is identified. The similarity is measured using Mean Squared Error (MSE), with the lowest MSE indicating the highest similarity. The minimum MSE and the corresponding position (motion vector mvₓ, mv_{y}) of each image block are recorded. Upon completing this process for one resolution, the process is repeated with a higher resolution image, using the minimum MSE position found in the previous resolution as the search center for each image block, within a certain range. Ultimately, this yields the minimum MSE and motion vectors for each image block of I₀ relative to the preceding and succeeding four frames.

### 3.2 Frame Importance

To calculate the frame-level importance, begin by computing the mean magnitude of the motion vectors mvₓ and mv_{y} for all image blocks in the four preceding and succeeding frames. Then, calculate the mean magnitude of the motion vectors for these eight frames. Finally, determine the frame-level importance as follows:

importance_{frame}=α·(m̅v̅ₓ+m̅v̅_{y})+β (1).

Frame-level importance indicates the degree of importance of the current I-frame in relation to other frames. A higher value signifies lower importance, suggesting that it is feasible to reduce its bitrate. This metric can be instrumental in optimizing the allocation of encoding resources, ensuring efficient bitrate usage without compromising the overall quality and effectiveness of the video encoding process.

### 3.3 Block Importance

To calculate block-level importance, start by iterating through each image block in the four frames preceding and succeeding the current I-frame (I₀). Based on the minimum Mean Squared Error (MSE) position for each of these image blocks, record the corresponding MSE value for the matching image block in I₀. Subsequently, compute the mean MSE value recorded for each image block in I₀. Finally, calculate the block-level importance as follows:

importance_{block}=γ·M̅S̅E̅ (2).

Block-level importance reflects the significance of the current image block in relation to other frames. A higher value indicates lower importance, suggesting that it is possible to reduce its bitrate. This assessment of importance helps in determining how much encoding resources should be allocated to each block.

### 3.4 Adaptive Block-level QP Adjustment

To adjust the block-level quantization parameters within the I-frame (I₀), iterate through each image block of I₀. The adjustment value for the block-level quantization parameter is calculated as follows:

ΔQP_{block}=clip(min,max,δ·importance_{frame}·importance_{block}+ε) (3),

where min and max are lower and upper bound of delta QP allowed, and the original block quantization parameter is modified by adding the block-level quantization parameter adjustment value. This results in the final block quantization parameter, which is then used for the final encoding process.

### 3.5 Detailed Solutions

1. The method for adaptive block-level quantization parameter adjustment in I-frames based on block importance and frame importance.
2. The calculation method for frame-level importance, for example, it can be evaluated with motion information, such as formula (1).
3. The calculation method for block-level importance, for example, it can be evaluated with the magnitude of prediction error, such as formula (2).
4. The calculation method for block-level quantization parameter adjustment.

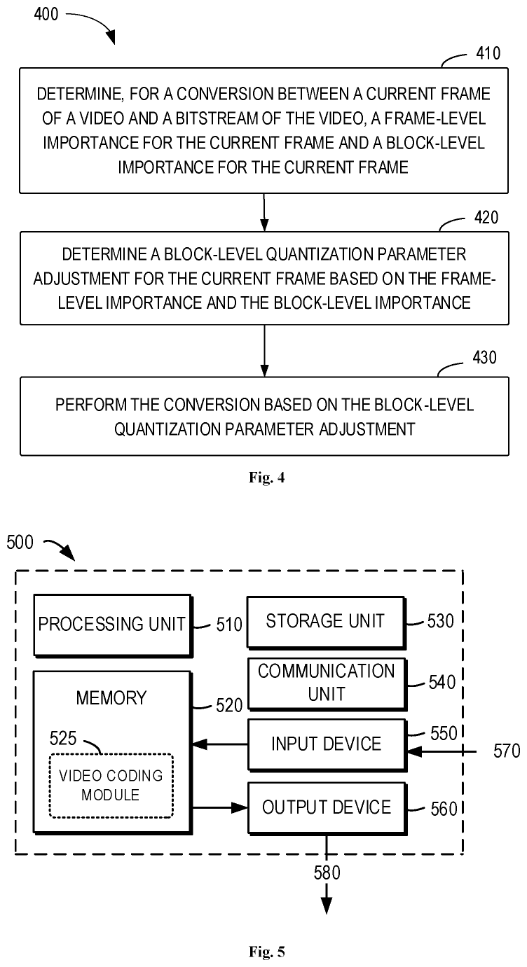

FIG. 4 illustrates a flowchart of a method 400 for video processing in accordance with embodiments of the present disclosure. The method 400 is implemented during a conversion between a video unit of a video and a bitstream of the video. The video unit may be a frame of the video, or any other suitable video unit.

At block 410, for a conversion between a current frame of a video and a bitstream of the video, a frame-level importance for the current frame and a block-level importance for the current frame are determined. The current frame may refer to a frame to be currently coded such as a frame to be encoded currently.

At block 420, a block-level quantization parameter adjustment for the current frame is determined based on the frame-level importance and the block-level importance. In some embodiments, the frame-level importance indicates a degree of importance of the current frame relative to other frames in the video. The other frames may be frames to be coded such as encoded subsequent to the current frame. In some embodiments, the block-level importance indicates a significance of a current image block in the current frame relative to other frames in the video.

At block 430, the conversion is performed based on the block-level quantization parameter adjustment. In some embodiments, the conversion includes decoding the current frame from the bitstream. Alternatively, or in addition, in some embodiments, the conversion includes encoding the current frame into the bitstream. That is, the determined block-level quantization parameter adjustment may be applied in an encoding process. For example, an original block-level quantization parameter may be adjusted based on the block-level quantization parameter during the encoding process.

The method 400 enables adjusting the block-level quantization parameter by considering both the frame-level importance and the block-level importance. Such adaptive block-level quantization parameter adjustment may improve the coding performance such as encoding performance.

In some embodiments, the current frame comprises a current I-frame of the video. The current I-frame may refer to an I-frame to be encoded currently. Initially, the frame importance of the current I-frame for subsequent frames to be encoded is analyzed. This is followed by an assessment of the block importance of each image block within the current I-frame in relation to subsequent frames to be encoded. Finally, based on the importance of the block and the frame, the current block's quantization parameter adjustment value is calculated, allowing for the modification of the quantization parameters of the current image block. This method ultimately reduces the bitrate of the I-frame and the fluctuation of the video bitrate, without impacting the encoding efficiency. It enables more effective utilization of the transmission bandwidth. In the following description, some embodiments will be described with the current frame being an I-frame as an example, but it is only for the purpose of illustration, without suggesting any limitation. The current frame may be other frame to be (en)coded such as the second or third frame in group of pictures (GOP) or frames with a lower hierarchy, or the like. Embodiments of the present disclosure is not limited here.

In some embodiments, determining the frame-level importance for the current frame comprises: determining at least one preceding frame before the current frame and at least one succeeding frame after the current frame; determining at least one motion vector for at least one block in the current frame based on similarities between the at least one block and a plurality of blocks in the at least one preceding frame and the at least one succeeding frame; and determining the frame-level importance based on the at least one motion vector. In some embodiments, the at least one preceding frame comprises four preceding frames, and the at least one succeeding frame comprises four succeeding frames. It is to be understood that the at least one preceding frame may include more or less preceding frames, and the at least one succeeding frame may include more or less preceding frames. For the purpose of illustration, some embodiments will be described with four preceding frames and four succeeding frames as an example. Those embodiments may also be applied to more or less preceding frames and/or more or less succeeding frames. Scope of the present disclosure is not limited here.

In some embodiments, determining the at least motion vector comprises: determining a position in a frame of the at least one preceding and succeeding frames, the position corresponding to a lowest similarity with the at least one block; and determining the at least one motion vector based on the position and at least one position of the at least one.

In some embodiments, the plurality of similarities are determined based on a plurality of mean squared errors between the at least one block and the plurality of blocks.

In some embodiments, the current frame, the at least one preceding frame and the at least one succeeding frame are downsampled along a width dimension and a height dimension to obtain a plurality of images with a resolution lower than a current image.

In some embodiments, image blocks of the at least one downsampled preceding frame and the at least one downsampled succeeding frame are traversed based on a range associated with a position of the current image, to obtain a target position in the at least one downsampled preceding frame and the at least one downsampled succeeding frame, the target position being associated with a highest similarity with the current block.

In some embodiments, images blocks of the at least one preceding frame and the at least one succeeding frame are traversed based on a range associated with the target position, to obtain a further target position in the at least one preceding frame and the at least one succeeding frame, the further target position being associated with a highest similarity with the current block.

In some embodiments, the current frame, the at least one preceding frame and the at least one succeeding frame are downsampled for a plurality of times, and the target position with a highest similarity with the current block is determined for downsampled frames at a plurality of resolutions. In some embodiments, the at least one motion vector comprises at least one first motion vector in a first direction and at least one second motion vector in a second direction. For example, 4 frames before and after the current I-frame I₀, namely B₁, B₂, B₃, B₄, B₅, B₆, B₇, Bg in total are identified. These frames, along with I₀, are downsampled twice along their width and height dimensions to obtain two lower resolution images. Starting with the image of the lowest resolution, the image blocks of the four preceding and succeeding frames are traversed. Within a certain range of the corresponding position of the current image block, the most similar image block in IO is identified. The similarity is measured using Mean Squared Error (MSE), with the lowest MSE indicating the highest similarity. The minimum MSE and the corresponding position (motion vector mvₓ, mv_{y}) of each image block are recorded. Upon completing this process for one resolution, the process is repeated with a higher resolution image, using the minimum MSE position found in the previous resolution as the search center for each image block, within a certain range. Ultimately, this yields the minimum MSE and motion vectors for each image block of I₀ relative to the preceding and succeeding four frames.

In some embodiments, determining the frame-level importance based on the at least one motion vector comprises: determining a mean magnitude of the at least one motion vector; and determining the frame-level importance based on the mean magnitude.

In some embodiments, the at least one motion vector comprises a plurality of first motion vectors in a first directions for blocks in a plurality of preceding and succeeding frames and a plurality of second motion vectors in a second direction for blocks in the plurality of preceding and succeeding frames, and the mean magnitude comprises a first mean magnitude of the plurality of first motion vectors and a second mean magnitude of the plurality of second motion vectors.

In some embodiments, the frame-level importance is determined by: importance_{frame}=α·(m̅v̅ₓ+m̅v̅_{y})+β, where m̅v̅ₓ denotes the first mean magnitude, m̅v̅_{y} denotes the second mean magnitude, a and B are parameters, and importance_{frame} denotes the frame-level importance. A higher value signifies lower importance, suggesting that it is feasible to reduce its bitrate. This metric may be instrumental in optimizing the allocation of encoding resources, ensuring efficient bitrate usage without compromising the overall quality and effectiveness of the video encoding process.

In some embodiments, determining the block-level importance for the current frame comprises: iterating a plurality of blocks in at least one preceding frame and at least one succeeding frame of the current frame to obtain a plurality of positions, each of the plurality of positions corresponding to a minimum mean squared error (MSE) for a matching block in the current frame; determining a value mean of a plurality of MSEs of the plurality of positions; and determining the block-level importance based on the mean value.

In some embodiments, the block-level importance is determined by importance_{block}=γ·M̅S̅E̅, where MSE denotes the mean value, y denotes a parameter, and importance_{block} denotes block-level importance. A higher value indicates lower importance, suggesting that it is possible to reduce its bitrate. This assessment of importance helps in determining how much encoding resources should be allocated to each block.

In some embodiments, the block-level quantization parameter adjustment is determined by: ΔQP_{block}=clip(min, max, δ·importance_{frame}·importance_{block}+ε), where min denotes an allowed lower bound of an allowed quantization parameter, max denotes an allowed upper bound of the quantization parameter, importance_{frame} denotes the frame-level importance, importance_{block} denotes block-level importance, δ and ε are parameters, clip( ) denotes a clipping operation, and ΔQP_{block} denotes the block-level quantization parameter adjustment.

Alternatively, in some embodiments, the block-level quantization parameter adjustment may be determined by:

$$Q {P}_{adjust} = ℱ ( IPI , BI ) = \{ \begin{matrix}0 , & \frac{1}{IPI} < {TH}_{p} \\ 𝒢 ( BI ) , & \frac{1}{IPI} \geq {TH}_{p}\end{matrix} , and$$

$$𝒢 ( BI ) = \{ \begin{matrix}0 , & \frac{1}{BI} < {TH}_{b 0} \\ {α}_{b} \cdot \frac{1}{BI} + {β}_{b} , & {TH}_{b 0} \leq \frac{1}{BI} \leq {TH}_{b 1} \\ {QP}_{max} , & \frac{1}{BI} > {TH}_{b 1}\end{matrix}$$

where IPI denotes the frame-level importance, BI denotes the block-level importance, TH_{b0}, TH_{b1} and THₚ denotes different thresholds, ab and Bb denotes parameters, and QP_{adjust} denotes the block-level quantization parameter adjustment.

In some embodiments, the block-level quantization parameter adjustment is added to an original block quantization parameter. This results in a final block quantization parameter, which is then used for the final encoding process. In this way, the adjusted quantization parameter may be used in the encoding process, and may increase the encoding quality and reduce the bitrate.

It is to be understood that these example calculations for the frame-level importance, the block-level importance and the block-level quantization parameter adjustment and those parameters in these calculations are only described for the purpose of illustration, without suggesting any limitation. Any suitable calculation may be applied for the block-level quantization parameter adjustment. Embodiments of the present is not limited here.

According to further embodiments of the present disclosure, a non-transitory computer-readable recording medium is provided. The non-transitory computer-readable recording medium stores a bitstream of a video which is generated by a method performed by an apparatus for video processing. In the method, a frame-level importance for a current frame of the video and a block-level importance for the current frame are determined. A block-level quantization parameter adjustment for the current frame is determined based on the frame-level importance and the block-level importance. The bitstream is generated based on the block-level quantization parameter adjustment.

According to still further embodiments of the present disclosure, a method for storing bitstream of a video is provided. In the method, a frame-level importance for a current frame of the video and a block-level importance for the current frame are determined. A block-level quantization parameter adjustment for the current frame is determined based on the frame-level importance and the block-level importance. The bitstream is generated based on the block-level quantization parameter adjustment. The bitstream is stored in a non-transitory computer-readable recording medium.

Implementations of the present disclosure can be described in view of the following clauses, the features of which can be combined in any reasonable manner.
Clause 1. A method of video processing, comprising: determining, for a conversion between a current frame of a video and a bitstream of the video, a frame-level importance for the current frame and a block-level importance for the current frame; determining a block-level quantization parameter adjustment for the current frame based on the frame-level importance and the block-level importance; and performing the conversion based on the block-level quantization parameter adjustment.
Clause 2. The method of clause 1, wherein the current frame comprises a current I-frame of the video.
Clause 3. The method of clause 1 or 2, wherein determining the frame-level importance for the current frame comprises: determining at least one preceding frame before the current frame and at least one succeeding frame after the current frame; determining at least one motion vector for at least one block in the current frame based on similarities between the at least one block and a plurality of blocks in the at least one preceding frame and the at least one succeeding frame; and determining the frame-level importance based on the at least one motion vector.
Clause 4. The method of clause 3, wherein determining the at least motion vector comprises: determining a position in a frame of the at least one preceding and succeeding frames, the position corresponding to a lowest similarity with the at least one block; and determining the at least one motion vector based on the position and at least one position of the at least one.
Clause 5. The method of clause 3 or 4, wherein the plurality of similarities are determined based on a plurality of mean squared errors between the at least one block and the plurality of blocks.
Clause 6. The method of any of clauses 3-5, wherein the current frame, the at least one preceding frame and the at least one succeeding frame are downsampled along a width dimension and a height dimension to obtain a plurality of images with a resolution lower than a current image.
Clause 7. The method of clause 6, wherein image blocks of the at least one downsampled preceding frame and the at least one downsampled succeeding frame are traversed based on a range associated with a position of the current image, to obtain a target position in the at least one downsampled preceding frame and the at least one downsampled succeeding frame, the target position being associated with a highest similarity with the current block.
Clause 8. The method of clause 7, wherein images blocks of the at least one preceding frame and the at least one succeeding frame are traversed based on a range associated with the target position, to obtain a further target position in the at least one preceding frame and the at least one succeeding frame, the further target position being associated with a highest similarity with the current block.
Clause 9. The method of clause 7 or 8, wherein the current frame, the at least one preceding frame and the at least one succeeding frame are downsampled for a plurality of times, and the target position with a highest similarity with the current block is determined for downsampled frames at a plurality of resolutions.
Clause 10. The method of any of clauses 3-9, wherein the at least one motion vector comprises at least one first motion vector in a first direction and at least one second motion vector in a second direction.
Clause 11. The method of any of clauses 3-10, wherein determining the frame-level importance based on the at least one motion vector comprises: determining a mean magnitude of the at least one motion vector; and determining the frame-level importance based on the mean magnitude.
Clause 12. The method of clause 11, wherein the at least one motion vector comprises a plurality of first motion vectors in a first directions for blocks in a plurality of preceding and succeeding frames and a plurality of second motion vectors in a second direction for blocks in the plurality of preceding and succeeding frames, and the mean magnitude comprises a first mean magnitude of the plurality of first motion vectors and a second mean magnitude of the plurality of second motion vectors.
Clause 13. The method of clause 12, wherein the frame-level importance is determined by: importance_{frame}=α·(m̅v̅ₓ+m̅v̅_{y})+β, wherein m̅v̅ₓ denotes the first mean magnitude, m̅v̅_{y} denotes the second mean magnitude, a and B are parameters, and importance_{frame} denotes the frame-level importance.
Clause 14. The method of any of clauses 1-13, wherein determining the block-level importance for the current frame comprises: iterating a plurality of blocks in at least one preceding frame and at least one succeeding frame of the current frame to obtain a plurality of positions, each of the plurality of positions corresponding to a minimum mean squared error (MSE) for a matching block in the current frame; determining a value mean of a plurality of MSEs of the plurality of positions; and determining the block-level importance based on the mean value.
Clause 15. The method of clause 14, wherein the block-level importance is determined by importance_{block}=γ·M̅S̅E̅, wherein MSE denotes the mean value, γ denotes a parameter, and importance_{block} denotes block-level importance.
Clause 16. The method of any of clauses 3-15, wherein the at least one preceding frame comprises four preceding frames, and the at least one succeeding frame comprises four succeeding frames.
Clause 17. The method of any of clauses 1-16, wherein the block-level quantization parameter adjustment is determined by: ΔQP_{block}=clip(min, max, δ·importance_{frame}·importance_{block}+ε), where min denotes an allowed lower bound of an allowed quantization parameter, max denotes an allowed upper bound of the quantization parameter, importance_{frame} denotes the frame-level importance, importance_{block} denotes block-level importance, δ and ε are parameters, clip( ) denotes a clipping operation, and ΔQP_{block} denotes the block-level quantization parameter adjustment.
Clause 18. The method of any of clauses 1-17, wherein the block-level quantization parameter adjustment is added to an original block quantization parameter.
Clause 19. The method of any of clauses 1-18, wherein the frame-level importance indicates a degree of importance of the current frame relative to other frames in the video.
Clause 20. The method of any of clauses 1-19, wherein the block-level importance indicates a significance of a current image block in the current frame relative to other frames in the video.
Clause 21. The method of any of clauses 1-20, wherein the conversion includes encoding the current frame into the bitstream.
Clause 22. The method of any of clauses 1-20, wherein the conversion includes decoding the current frame from the bitstream.
Clause 23. An apparatus for video processing comprising a processor and a non-transitory memory with instructions thereon, wherein the instructions upon execution by the processor, cause the processor to perform a method in accordance with any of clauses 1-22.
Clause 24. A non-transitory computer-readable storage medium storing instructions that cause a processor to perform a method in accordance with any of clauses 1-22.
Clause 25. A non-transitory computer-readable recording medium storing a bitstream of a video which is generated by a method performed by an apparatus for video processing, wherein the method comprises: determining a frame-level importance for a current frame of the video and a block-level importance for the current frame; determining a block-level quantization parameter adjustment for the current frame based on the frame-level importance and the block-level importance; and generating the bitstream based on the block-level quantization parameter adjustment.
Clause 26. A method for storing a bitstream of a video, comprising: determining a frame-level importance for a current frame of the video and a block-level importance for the current frame; determining a block-level quantization parameter adjustment for the current frame based on the frame-level importance and the block-level importance; generating the bitstream based on the block-level quantization parameter adjustment; and storing the bitstream in a non-transitory computer-readable recording medium.

### Example Device

FIG. 5 illustrates a block diagram of a computing device 500 in which various embodiments of the present disclosure can be implemented. The computing device 500 may be implemented as or included in the source device 110 (or the video encoder 114 or 200) or the destination device 120 (or the video decoder 124 or 300).

It would be appreciated that the computing device 500 shown in FIG. 5 is merely for purpose of illustration, without suggesting any limitation to the functions and scopes of the embodiments of the present disclosure in any manner.

As shown in FIG. 5, the computing device 500 includes a general-purpose computing device 500. The computing device 500 may at least comprise one or more processors or processing units 510, a memory 520, a storage unit 530, one or more communication units 540, one or more input devices 550, and one or more output devices 560.

In some embodiments, the computing device 500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 500 can support any type of interface to a user (such as “wearable” circuitry and the like).

The processing unit 510 may be a physical or virtual processor and can implement various processes based on programs stored in the memory 520. In a multi-processor system, multiple processing units execute computer executable instructions in parallel so as to improve the parallel processing capability of the computing device 500. The processing unit 510 may also be referred to as a central processing unit (CPU), a microprocessor, a controller or a microcontroller.

The computing device 500 typically includes various computer storage medium. Such medium can be any medium accessible by the computing device 500, including, but not limited to, volatile and non-volatile medium, or detachable and non-detachable medium. The memory 520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 530 may be any detachable or non-detachable medium and may include a machine-readable medium such as a memory, flash memory drive, magnetic disk or another other media, which can be used for storing information and/or data and can be accessed in the computing device 500.

The computing device 500 may further include additional detachable/non-detachable, volatile/non-volatile memory medium. Although not shown in FIG. 5, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 540 communicates with a further computing device via the communication medium. In addition, the functions of the components in the computing device 500 can be implemented by a single computing cluster or multiple computing machines that can communicate via communication connections. Therefore, the computing device 500 can operate in a networked environment using a logical connection with one or more other servers, networked personal computers (PCs) or further general network nodes.

The input device 550 may be one or more of a variety of input devices, such as a mouse, keyboard, tracking ball, voice-input device, and the like. The output device 560 may be one or more of a variety of output devices, such as a display, loudspeaker, printer, and the like. By means of the communication unit 540, the computing device 500 can further communicate with one or more external devices (not shown) such as the storage devices and display device, with one or more devices enabling the user to interact with the computing device 500, or any devices (such as a network card, a modem and the like) enabling the computing device 500 to communicate with one or more other computing devices, if required. Such communication can be performed via input/output (I/O) interfaces (not shown).

In some embodiments, instead of being integrated in a single device, some or all components of the computing device 500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 500 may be used to implement video encoding/decoding in embodiments of the present disclosure. The memory 520 may include one or more video coding modules 525 having one or more program instructions. These modules are accessible and executable by the processing unit 510 to perform the functionalities of the various embodiments described herein.

In the example embodiments of performing video encoding, the input device 550 may receive video data as an input 570 to be encoded. The video data may be processed, for example, by the video coding module 525, to generate an encoded bitstream. The encoded bitstream may be provided via the output device 560 as an output 580.

In the example embodiments of performing video decoding, the input device 550 may receive an encoded bitstream as the input 570. The encoded bitstream may be processed, for example, by the video coding module 525, to generate decoded video data. The decoded video data may be provided via the output device 560 as the output 580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method of video processing, comprising:
determining, for a conversion between a current frame of a video and a bitstream of the video, a frame-level importance for the current frame and a block-level importance for the current frame;
determining a block-level quantization parameter adjustment for the current frame based on the frame-level importance and the block-level importance; and
performing the conversion based on the block-level quantization parameter adjustment.

2. The method of claim 1, wherein the current frame comprises a current I-frame of the video.

3. The method of claim 1, wherein determining the frame-level importance for the current frame comprises:
determining at least one preceding frame before the current frame and at least one succeeding frame after the current frame;
determining at least one motion vector for at least one block in the current frame based on similarities between the at least one block and a plurality of blocks in the at least one preceding frame and the at least one succeeding frame; and
determining the frame-level importance based on the at least one motion vector.

4. The method of claim 3, wherein determining the at least motion vector comprises:
determining a position in a frame of the at least one preceding and succeeding frames, the position corresponding to a lowest similarity with the at least one block; and
determining the at least one motion vector based on the position and at least one position of the at least one.

5. The method of claim 3, wherein the plurality of similarities are determined based on a plurality of mean squared errors between the at least one block and the plurality of blocks.

6. The method of claim 3, wherein the current frame, the at least one preceding frame and the at least one succeeding frame are downsampled along a width dimension and a height dimension to obtain a plurality of images with a resolution lower than a current image.

7. The method of claim 6, wherein image blocks of the at least one downsampled preceding frame and the at least one downsampled succeeding frame are traversed based on a range associated with a position of the current image, to obtain a target position in the at least one downsampled preceding frame and the at least one downsampled succeeding frame, the target position being associated with a highest similarity with the current block.

8. The method of claim 7, wherein images blocks of the at least one preceding frame and the at least one succeeding frame are traversed based on a range associated with the target position, to obtain a further target position in the at least one preceding frame and the at least one succeeding frame, the further target position being associated with a highest similarity with the current block, and/or
wherein the current frame, the at least one preceding frame and the at least one succeeding frame are downsampled for a plurality of times, and the target position with a highest similarity with the current block is determined for downsampled frames at a plurality of resolutions.

9. The method of claim 3, wherein the at least one motion vector comprises at least one first motion vector in a first direction and at least one second motion vector in a second direction.

10. The method of claim 3, wherein determining the frame-level importance based on the at least one motion vector comprises:
determining a mean magnitude of the at least one motion vector; and
determining the frame-level importance based on the mean magnitude.

11. The method of claim 10, wherein the at least one motion vector comprises a plurality of first motion vectors in a first directions for blocks in a plurality of preceding and succeeding frames and a plurality of second motion vectors in a second direction for blocks in the plurality of preceding and succeeding frames, and the mean magnitude comprises a first mean magnitude of the plurality of first motion vectors and a second mean magnitude of the plurality of second motion vectors,
wherein the frame-level importance is determined by: importance_{frame}=α·(m̅v̅ₓ+m̅v_{y})+β, wherein m̅v̅ₓ denotes the first mean magnitude, m̅v̅_{y} denotes the second mean magnitude, α and β are parameters, and importance_{frame} denotes the frame-level importance.

12. The method of claim 1, wherein determining the block-level importance for the current frame comprises:
iterating a plurality of blocks in at least one preceding frame and at least one succeeding frame of the current frame to obtain a plurality of positions, each of the plurality of positions corresponding to a minimum mean squared error (MSE) for a matching block in the current frame;
determining a value mean of a plurality of MSEs of the plurality of positions; and
determining the block-level importance based on the mean value.

13. The method of claim 12, wherein the block-level importance is determined by importance_{block}=γ·M̅S̅E̅, wherein MSE denotes the mean value, γ denotes a parameter, and importance_{block} denotes block-level importance.

14. The method of claim 3, wherein the at least one preceding frame comprises four preceding frames, and the at least one succeeding frame comprises four succeeding frames.

15. The method of claim 1, wherein the block-level quantization parameter adjustment is determined by: ΔQP_{block}=clip(min, max, δ·importance_{frame}·importance_{block}+ε),
where min denotes an allowed lower bound of an allowed quantization parameter, max denotes an allowed upper bound of the quantization parameter, importance_{frame} denotes the frame-level importance, importance_{block} denotes block-level importance, δ and ε are parameters, clip( ) denotes a clipping operation, and ΔQP_{block} denotes the block-level quantization parameter adjustment.

16. The method of claim 1, wherein the block-level quantization parameter adjustment is added to an original block quantization parameter, and/or
wherein the frame-level importance indicates a degree of importance of the current frame relative to other frames in the video, and/or
wherein the block-level importance indicates a significance of a current image block in the current frame relative to other frames in the video.

17. The method of claim 1, wherein the conversion includes encoding the current frame into the bitstream,
wherein the conversion includes decoding the current frame from the bitstream.

18. The method of claim 1, wherein the conversion comprises: generating the bitstream from the video, and
the method further comprises: storing the bitstream in a non-transitory computer-readable recording medium.

19. An apparatus for video processing comprising a processor and a non-transitory memory with instructions thereon, wherein the instructions upon execution by the processor, cause the processor to:
determine, for a conversion between a current frame of a video and a bitstream of the video, a frame-level importance for the current frame and a block-level importance for the current frame;
determine a block-level quantization parameter adjustment for the current frame based on the frame-level importance and the block-level importance; and
perform the conversion based on the block-level quantization parameter adjustment.

20. A non-transitory computer-readable storage medium storing instructions that cause a processor to perform operations comprising:
determining, for a conversion between a current frame of a video and a bitstream of the video, a frame-level importance for the current frame and a block-level importance for the current frame;
determining a block-level quantization parameter adjustment for the current frame based on the frame-level importance and the block-level importance; and
performing the conversion based on the block-level quantization parameter adjustment.
